(19) United States
(12) Patent Application Publication
(10) Pub. No.: US 2023/0022835 A1
(43) Pub. Date: Jan. 26, 2023

(54) PARTICULATE MATTER SENSING DEVICE AND METHOD FOR CONTROLLING DRIVING OF THE SAME

(71) Applicants: HYUNDAI MOTOR COMPANY, SEOUL (KR); KIA CORPORATION, SEOUL (KR)

(72) Inventors: Il Seon Yoo, Suwon-si (KR); Dae Sung Kwon, Seoul (KR); Dong Gu Kim, Suwon-si (KR); Hyun Soo Kim, Yongin-si (KR)

(21) Appl. No.: 17/729,351

(22) Filed: Apr. 26, 2022

(30) Foreign Application Priority Data
Jul. 21, 2021 (KR) 10-2021-0096011

(51) Int. Cl. G01N 15/02

(52) U.S. Cl. CPC G01N 15/0266; G01N 2015/0065

(57) ABSTRACT

A particulate matter sensing device includes an inlet through which air is introduced, a particle classifying unit classifying particles included in air introduced through the inlet, a corona discharging unit electrifying the particles passing through the particle classifying unit, and a sensing unit collecting the particles electrified by the corona discharging unit, in which the sensing unit includes an electrode having a plurality of intervals to collect the particles electrified by the sensing unit, and a control unit determining whether fine particles are detected, based on a result of monitoring an output signal change of the electrode.

### CROSS REFERENCE TO RELATED APPLICATIONS

The present application claims priority to Korean Patent Application No. 10-2021-0096011, filed Jul. 21, 2021, the entire contents of which is incorporated herein for all purposes by this reference.

### BACKGROUND

### Field

The present disclosure relates to a particulate matter sensing device and a method for controlling driving of the same, and more particularly, to a particulate matter sensing device that detects a harmful substance in a vehicle and removes the detected harmful substance, and a method for controlling driving of the particulate matter sensing device.

### Description of the Related Art

As social hygiene concerns increase due to COVID-19 and the expansion of shared vehicles, a need for hygiene management in vehicles has emerged. Although techniques for removing and preventing harmful substances in vehicles have been actively developed, research and application of sensing technology are still insufficient.

Korean Patent Registration No. 10-1853104 discloses a technique in which when light output from a light source is scattered by floating fine particles, the scattered light is received and the amount of particles is measured. In Korean Patent Registration No. 10-1853104, accuracy and precision are improved using a variable gain amplification circuit and a background correction circuit. Meanwhile, to measure ultra-fine particles and low-concentration particles, a beam size of a light source needs to be small and a micro-signal has to be measured by a receiving unit. Such an optical sensor system is limited in application to a vehicle due to a need for expensive parts.

Therefore, there is a need for a device for a vehicle, which is capable of providing information about harmful substances to vehicle users and removing the harmful substances.

The matters described as the background art are merely for improving the understanding of the background of the present disclosure, and should not be accepted as acknowledging that they correspond to the prior art known to those of ordinary skill in the art.

### SUMMARY

The present disclosure is proposed to solve these problems and aims to provide a particulate matter sensing technique for selectively sensing fine particles floating in a vehicle in real time.

In particular, the present disclosure aims to provide a particulate matter sensing technique for sensing a small amount of fine particles and collecting and selectively removing the sensed fine particles.

The present disclosure also aims to implement a particulate matter sensing device to estimate a particulate matter to be removed based on an output signal detected by the particulate matter sensing device and to share estimated particulate matter information with a vehicle user.

A particulate matter sensing device according to an embodiment of the present disclosure to achieve the foregoing aims includes an inlet through which air is introduced, a particle classifying unit classifying particles included in air introduced through the inlet, a corona discharging unit electrifying the particles passing through the particle classifying unit, and a sensing unit collecting the particles electrified by the corona discharging unit.

The sensing unit may include an electrode having a plurality of intervals to collect the particles electrified by the sensing unit, and a control unit determining whether fine particles are detected, based on a result of monitoring an output signal change of the electrode.

The particulate matter sensing device may further include a heater increasing a temperature of a side of the sensing unit.

The particulate matter sensing device may further include a heater installed under the electrode to increase a temperature of a side of the electrode, in which the control unit operates the heater according to the output signal change of the electrode.

The control unit may previously store reaction temperature information of fine particles matched according to types of the fine particles, and the control unit may determine information of detected fine particles, by comparing a temperature at which the output signal change of the electrode occurs when operating the heater with the previously stored reaction temperature information.

Thus, when the control unit operates the heater, the control unit may drive the heater at the preset first voltage to monitor the output signal change of the electrode, and drive the heater at the preset second voltage to remove the particles remaining in the sensing unit.

The particle classifying unit may be a virtual impactor including a major flow unit and a minor flow unit.

The sensing unit may include a plurality of insulating protrusions extending in a side longitudinal direction on the substrate, an interdigitated electrode (IDE) electrode applied to be arranged alternately in parallel on a sidewall part of the insulating protrusions, and a heater installed to heat the insulating protrusions.

The inlet may be connected to an inside of a vehicle to introduce air in the inside of the vehicle, the sensing unit may be connected to an outlet for discharging the air to an outside, and a fan may be installed in a discharging path connecting the sensing unit with the outlet.

The particulate matter sensing device may further include a substrate on which the particle classifying unit, the corona discharging unit, and the sensing unit are installed, a housing installed on the substrate, the housing on which a flow path connecting the inlet with the outlet is partitioned, and a cover covering a side of the housing, in which the particulate matter sensing device may be modularized by the housing and the cover.

A method for controlling driving of a particulate matter sensing device according to a preferred implementation example of the present disclosure includes a particle classifying operation of classifying fine particles of air introduced through an inlet, by a particle classifying unit, a particle electrifying operation of electrifying fine particles, by a corona discharging unit, a signal generating operation of generating an output signal by collecting the electrified fine particles, by a sensing unit including an interdigitated electrode (IDE) electrode, and a sensing operation of detecting the fine particles based on a change of the output signal, by a control unit.

The sensing operation may include a heater operating operation of operating a heater to heat a side of the sensing unit, when determining that the fine particles of a reference amount or more are collected between electrodes, by the control unit.

The control unit may previously store reaction temperature information of fine particles matched according to types of the fine particles, and the sensing operation may further include, after the heater operating operation, determining information of detected fine particles, by comparing a temperature at which the change of the output signal of the electrode occurs when operating the heater with the previously stored reaction temperature information, by the control unit.

The heater driving operation may include a first heater driving operation of driving the heater at the preset first voltage, by the control unit and a second heater driving operation of removing the particles remaining in the sensing unit by driving the heater to the preset second voltage after an elapse of a specific time.

With the particulate matter sensing device and the method for controlling driving of the same according to the present disclosure, a sensor capable of detecting the fine particles floating in the vehicle in real time and selectively may be provided.

In particular, according to the present disclosure, by using the corona discharging unit and the nanogap sensing unit, a small amount of fine particles may be effectively sensed.

Moreover, according to the present disclosure, bacteria and super-fine dust may be selective removed based on a heating temperature of the heater formed in the sensing unit, and an attenuation signal output from the sensing unit may be analyzed, thus estimating information about the sensed particulate matter.

Therefore, according to a preferred implementation example of the present disclosure, particles sensed by the sensing unit may be removed immediately after heater driving, enabling measurement and removal of fine particles at the same time.

### BRIEF DESCRIPTION OF THE FIGURES

FIG. 1 is a structural diagram showing a detailed structure of a particulate matter sensing device, according to an embodiment of the present disclosure;

FIG. 2 is a structural diagram showing main components of a particulate matter sensing device, divided by region, according to an embodiment of the present disclosure;

FIG. 3 is a conceptual diagram conceptually showing classification of fine particles in a particle classifying unit of a particulate matter sensing device, according to an embodiment of the present disclosure;

FIG. 4 is a conceptual diagram conceptually showing attachment of ions to fine particles by electrifying the fine particles in a corona discharging unit of a particulate matter sensing device, according to an embodiment of the present disclosure;

FIG. 5 is a cross-sectional view of a sensing unit of a particulate matter sensing device, according to an embodiment of the present disclosure;

FIGS. 6A, 6B, 6C, and 6D show examples of an interdigitated electrode (IDE) electrode manufacturing method in a sensing unit of a particulate matter sensing device, according to an embodiment of the present disclosure;

FIGS. 7A, 7B, 7C, and 7D show a cross section of a sensing unit for each operation of FIG. 6;

FIGS. 8A, 8B, 8C, 8D, and 8E show examples of an IDE electrode manufacturing method in a sensing unit of a particulate matter sensing device, according to an embodiment of the present disclosure;

FIG. 9 is a conceptual diagram showing an example of selectively depositing metal on a sidewall and a top surface of a protrusion on a substrate with a concave-convex structure;

FIG. 10 is a flowchart showing a method for controlling driving of a particulate matter sensing device, according to an embodiment of the present disclosure;

FIGS. 11A, 11B, 11C, and 11D are graphs showing temperature and current changes over time for each operation in a method for controlling driving of a particulate matter sensing device, according to an embodiment of the present disclosure; and

FIGS. 12A, 12B, 12C, and 12D show a state of a sensing unit for each operation to describe an operating principle where fine particles are collected and removed, in a method for controlling driving of a particulate matter sensing device, according to an embodiment of the present disclosure.

### DETAILED DESCRIPTION

Hereinafter, a particulate matter sensing device and a method for controlling driving of the same according to various embodiments of the present disclosure will be described in detail with reference to the attached drawings.

A particulate matter sensing device according to the present disclosure may have a modularized structure that may be installed in a vehicle and may have a structure connected to an indoor of the vehicle to introduce the air inside the vehicle and then discharge the air again. Preferably, the particulate matter sensing device may have a structure in which a corona discharging unit, a sensing unit, etc., are installed on a single substrate and an internal flow path is formed to allow the air including a particulate matter to flow therein.

The particulate matter sensing device according to the present disclosure may provide a sensor structure and an operating algorithm for simultaneously measuring bacteria and fine dust floating in the air inside the vehicle through one sensing unit. In this regard, the operating algorithm of a sensor may be based on a principle for measuring an electrical signal change occurring due to sequential removal of particles. Most bacteria are dissipated within several seconds at a temperature of 130° C. or higher, and ultra-fine dust may be removed within several seconds at a temperature of 500° C. or higher. Thus, by using a difference between temperatures at which two particles, i.e., bacteria and ultra-fine dust are removed, a temperature near an electrode where the fine particles are collected is sequentially increased, enabling selective and sequential removal of particles. When the operating algorithm of the particulate matter sensing device is implemented, a scheme of measuring electrical characteristics, e.g., a change of current may be used.

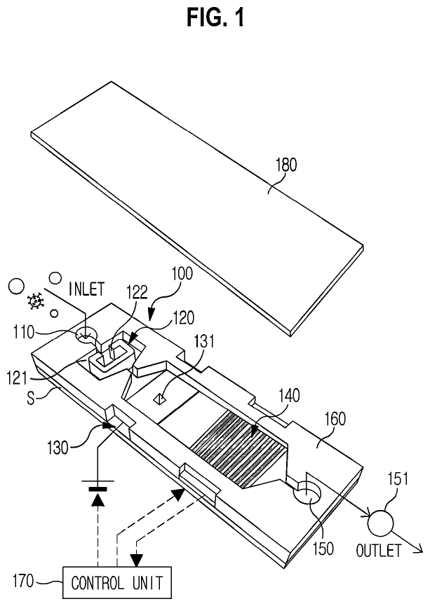

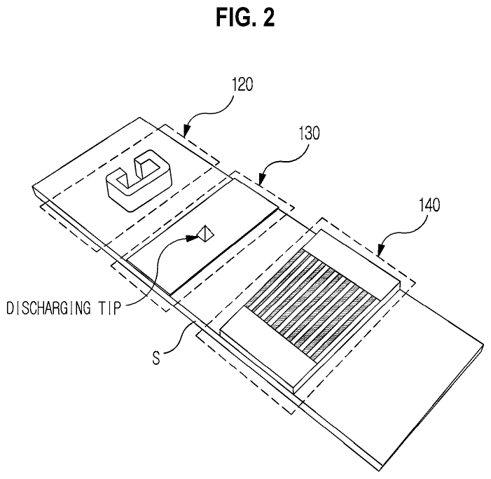

In this regard, FIG. 1 is a structural diagram showing a schematic structure of a particulate matter sensing device according to an embodiment of the present disclosure, and FIG. 2 shows main components related to FIG. 1, divided by region.

As shown in FIG. 1, a particulate matter sensing device 100 according to an embodiment of the present disclosure may include an inlet 110 formed in a side thereof through which the air is introduced, and an outlet 150 formed in the other side thereof through which the air passing through the inside of the particulate matter sensing device 100 is exhausted to the outside. A fan may be installed in a side of the outlet 150, and by driving the fan, air flow to the outlet 150 from the inlet 110 may be caused.

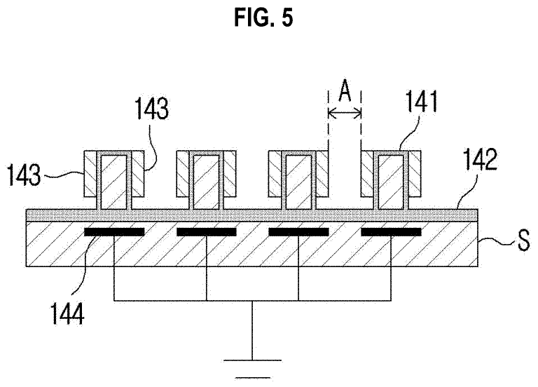

The air entering the particulate matter sensing device 100 after passing through the inlet 110 may be classified by the particle classifying unit 120 according to a particle size, and classified fine particles may move to a side of the corona discharging unit 130. The fine particles moved to the corona discharging unit 130 may be electrified by the corona discharging unit 130, and the electrified fine particles may move to a side of the sensing unit 140. The fine particles moved to the sensing unit 140 may be collected around the electrode of the sensing unit 140, and the collected particles may be removed by driving of a heater 144 (shown in FIG. 5) in the sensing unit 140.

The particle classifying unit 120, the corona discharging unit 130, and the sensing unit 140 may be installed on a substrate S, and the particulate matter sensing device 100 may be integrated into a housing 160 during the manufacturing process. A flow path connecting the inlet 110 with the outlet 150 is partitioned, and a cover 180 covering the housing 160 on the substrate S.

Hereinbelow, referring to FIGS. 1 and 2, main components of the particulate matter sensing device 100 will be described. The air introduced through the inlet 110 may be classified by the particle classifying unit 120. The particle classifying unit 120 may classify fine particles introduced through the inlet 110 according to sizes, and move the fine particles to the corona discharging unit 130 and the sensing unit 140.

For example, the particle classifying unit 120 may be a virtual impactor including a major flow unit 121 and a minor flow unit 122. The virtual impactor is widely used in sampling of particles with the advantages of high performance and real-time classification.

The fine particles introduced through an inlet of the virtual impactor may be accelerated while passing through a flow path with a cross section called a spray nozzle which gradually narrows. Major flow may be formed through a flow path bent at a right angle of 90 degrees, and minor flow may be formed through a flow path formed to go in a straight line. In this case, particles with high inertia may go in a straight line to move to a side of the minor flow unit 122, and particles with low inertia may mostly move to the major flow unit 121 bent 90 degrees where flow is concentrated. Based on such a principle, fine particles may be classified according to particle sizes through the virtual impactor. A classification particle diameter of the virtual impactor may be determined by a cross-sectional area and a flow rate of the spray nozzle, such that the particulate matter sensing device 100 according to the present disclosure may properly select a particle diameter of a fine particle to be detected and removed by adjusting the cross-sectional area and the flow rate of the nozzle.

For example, to improve sensing accuracy for each particle size, the fine particles may be classified according to sizes into ultra-fine particles having a size of 2.5 μm or less before cation attachment and fine particles having a size greater than 2.5 μm. By using a flow speed difference between the major flow unit 121 and the minor flow unit 122 of a flow path designed for a particle size desired to be measured, classification by particle size may be possible based on an inertia difference according to particle mass.

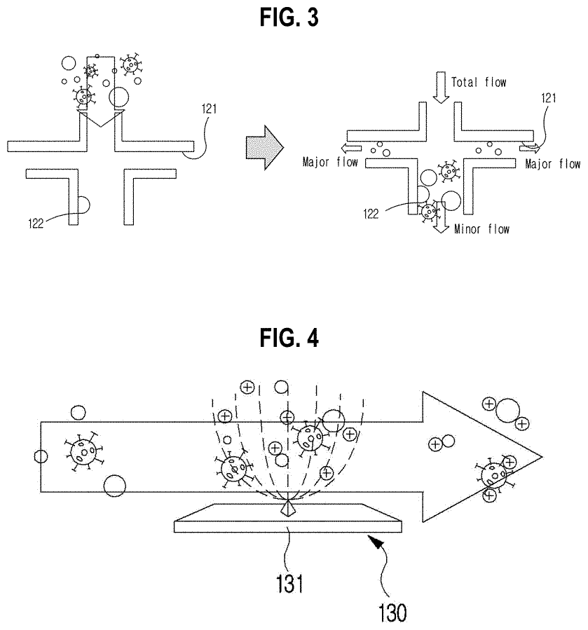

FIG. 1 shows an example having applied thereto the particle classifying unit 120 where a flow path with a geometric structure of such a virtual impactor is formed, and FIG. 3 shows an example where particles are classified in the virtual impactor.

As shown in FIG. 3, the virtual impactor applicable as the particle classifying unit 120 may have an inlet-side flow path formed therein, which is connected from the side of the inlet 110 to introduce the air, and may include the major flow unit 121 bent in a 90-degree direction with respect to the inlet-side flow path and the minor flow unit 122 for allowing flow in a straight direction. As shown in FIG. 3, large particles may go straight to move to the side of the minor flow unit 122, and may be collected in the particle classifying unit 120 as shown in FIG. 1. On the other hand, small particles may move to the main flow unit 121 and then to the corona discharging unit 130.

As shown in FIG. 1, in the particulate matter sensing unit 100 according to a preferred implementation example of the present disclosure, a flow path for forming such flow may be formed therein, and preferably, the housing 160 manufactured according to a predetermined flow path shape may be installed on the substrate S. As shown in FIG. 1, the housing 160 may be largely divided into a first space for the particle classifying unit 120 and a second space for the corona discharging unit 130 and the sensing unit 140. Between the first space and the second space, a narrow hole may be formed to allow air flow to an electrode tip 131 of the corona discharging unit 130.

The corona discharging unit 130 may include a corona discharging electrode installed on the insulating substrate S. The corona discharging unit 130 may be a component for attaching cations to fine particles included in the introduced air. When high voltage is applied to the corona discharging unit 130 through an electrode exposed to the outside of the housing 160 of the corona discharging unit 130, fine particles in the air moving on the corona discharging unit 130 may be electrified.

In this regard, in FIG. 4, it is illustrated that cations are attached to fine particles by the corona discharging unit 130, and in FIG. 4, it is described that after cations are attached to fine particles in a corona discharging zone formed by the sharp corona discharging electrode tip 131, the fine particles move downstream. Thus, the fine particles classified by the particle classifying unit 120 may be electrified through the corona discharging unit 130 before they are introduced to the sensing unit 140.

The sensing unit 140 may be installed in a downstream side of the corona discharging unit 130, and is a component for collecting fine particles electrified by the corona discharging unit 130. The sensing unit 140 of the particulate matter sensing device 100 according to a preferred embodiment of the present disclosure may have a structure in which the heater 144 and a nano gap interdigitated electrode (IDE) electrode are integrated, and may be manufactured through various MEMS (micro-electromechanical system) processes.

In this regard, FIG. 5 is a cross-sectional view of the sensing unit 140 of the particulate matter sensing device 100, according to an embodiment of the present disclosure. As shown in FIG. 5, the sensing unit 140 may include an insulating layer 142 applied onto the substrate S and an IDE electrode 143 exposed to the outside of the insulating layer 142. In particular, the sensing unit 140 may include IDE electrodes 143 arranged alternately with a plurality of intervals A therebetween to collect the electrified particles, and the heater 144 buried under the IDE electrode 143 to increase a temperature at the side of the sensing unit 140. More specifically, the sensing unit 140 may include a plurality of insulating protrusions 141 extending in a side longitudinal direction on the substrate S, the IDE electrode 143 applied to be arranged alternately with the interval A in parallel on a sidewall portion of the insulating protrusions 141, and the heater 144 installed to heat the insulating protrusions 141. The electrified fine particles may be collected on surfaces of the IDE electrodes 143, and may be removed by driving of the heater 144. Although not shown, a sensor for detecting temperature and current of the sensing unit 140 may be installed in the sensing unit 140.

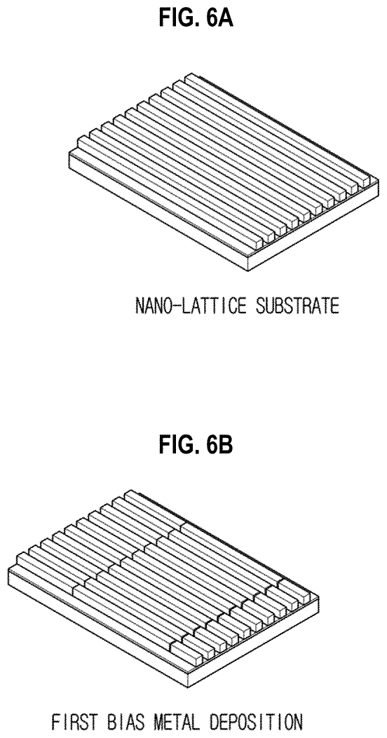

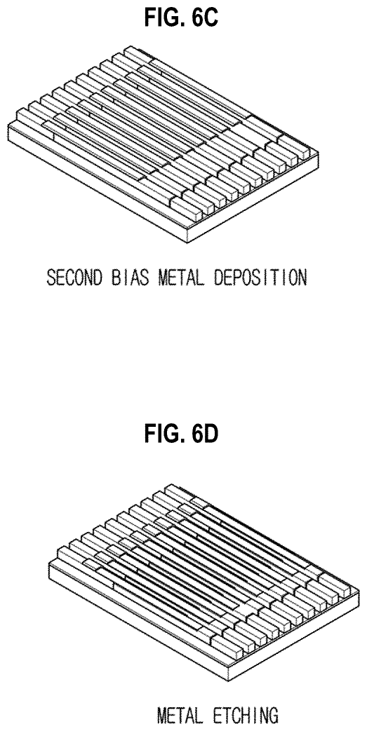

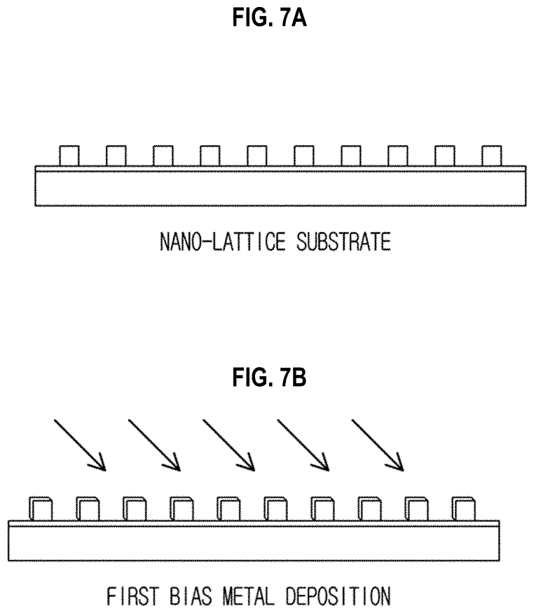

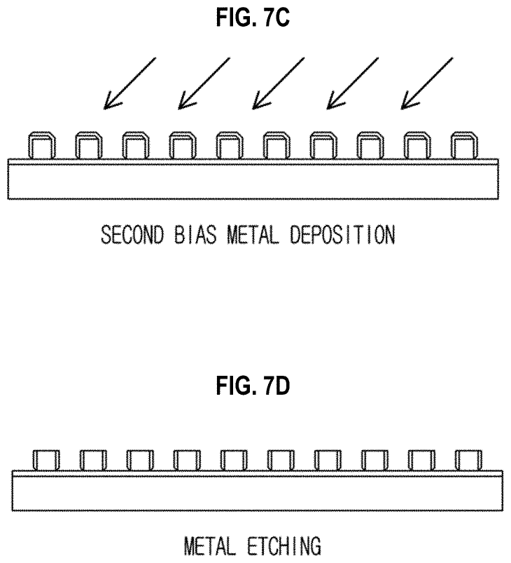

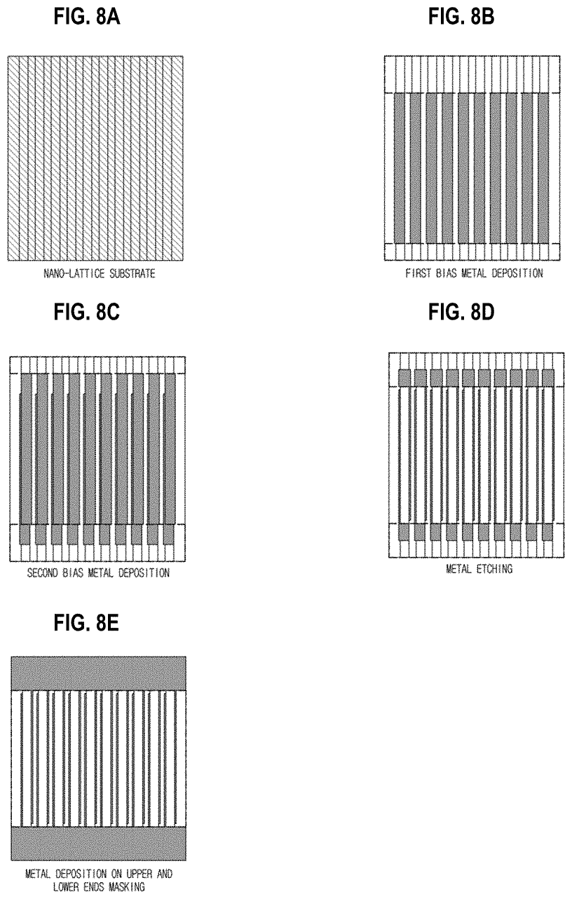

An embodiment of a method for manufacturing the sensing unit 140 having such a shape will be described with reference to FIGS. 6 through 9. FIG. 6 shows the steps of an example of an IDE electrode manufacturing method of the sensing unit 140 of the particulate matter sensing device 100 according to an embodiment of the present disclosure, and FIG. 7 shows a cross section of the sensing unit 140 for each operation of FIG. 6. FIG. 8 shows a state viewed from a substrate for each process operation in the same process.

As shown in FIGS. 6 and 7, a nanolattice substrate where the insulating layer 142 such as SiO₂, Si₃N₄, etc., is formed may be manufactured through thermal oxidation, chemical vapor deposition, etc. (FIGS. 6A, 7A, and 8A).

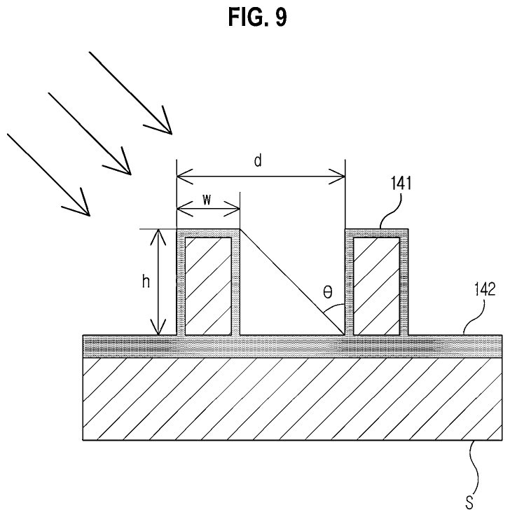

Thereafter, by using a deposition process having good directionality, thin film deposition may be carried out such that metal may be deposited on one wall and a top of a convex-concave structure in an inclined state of the substrate. In this regard, FIG. 9 is a conceptual diagram showing an example of selectively depositing metal on a sidewall and a top surface of the protrusion 141 on the substrate with the concave-convex structure. The substrate may be inclined according to an angle θ between a virtual line, which connects top and bottom ends of the adjacent protrusions 141 of the concave-convex structure, and a substrate bottom surface, and a beam may be shot, thus performing the deposition process. The angle for inclining the substrate may be determined based on a protrusion height h, a protrusion width w, and a protrusion interval d of the concave-convex structure, and preferably, the angle for inclining the substrate may be greater than the angle θ determined by an equation ‘tan(θ)=(d−w)/h’, thus performing the deposition process. In this case, a dotted region of FIG. 8B may mean a masking region.

By performing the deposition process as shown in FIG. 9 when some regions of upper and lower portions are masked as shown in FIG. 8B, a metal thin film may be deposited on a sidewall and a top surface of the protrusion 141 as shown in FIGS. 6B and 7B (first bias metal deposition).

Meanwhile, a subsequent process may be performed to deposit metal on a sidewall in an opposite direction to the metal-deposited sidewall as shown in FIGS. 6B and 7B. Such a process may be performed by a process of inclining the substrate to enable deposition in the opposite direction. As shown in FIGS. 6C and 7C, metal deposition is performed again on a sidewall and a top surface of the protrusion 141 in the opposite direction (second bias metal deposition). Likewise, some regions of the upper and lower portions may be controlled as mask regions where metal deposition is not performed (FIG. 8C).

Thereafter, as shown in FIG. 8D, a part where an electrode is to be formed may be masked, and the metal thin film on the top surface may be etched through an etching process such as reactive ion etching (RIE). Through such an etching process, as shown in FIGS. 6D and 7D, the metal thin film on the top surface of the protrusion 141 may be removed and the metal thin film on the sidewall of the protrusion 141 may remain, and as shown in FIG. 8E, metal deposition with respect to remainders of upper and lower ends may be performed to form an electrode.

Meanwhile, a method for manufacturing an electrode part may be merely an example, and the sensing unit 140 may be manufactured using another manufacturing method. For example, a heater may be previously formed by a photolithography process by using an electron beam (E-beam) lithography process, and an insulating film such as SiO₂, Si₃N₄, etc., may be formed on a heater electrode upper end, after which a nanogap IDE may be formed by using the E-beam lithography process.

Moreover, a suspended photoresist (PR) may be formed on a substrate where the heater and the insulating film are formed through PR patterning in a way to use carbon-MEMS (C-MEMS), and the diameter of the suspended PR may be reduced to a nanoscale using PR carbonization. Thereafter, metal may be deposited using the suspended PR as a shadow mask, and then the carbonized PR may be removed to form a nano gap electrode pattern.

Meanwhile, the control unit 170 may be connected to the IDE electrode 143, and the control unit 170 may be configured to monitor an electrical output signal change of the electrode and control driving of the heater 144 under the electrode. For example, the sensing unit 140 may be configured to sense a fine particle/bacteria concentration change by monitoring a resistance/impedance change of the electrode.

The control unit 170 may determine whether fine particles are detected, based on a result of monitoring the output signal change of the IDE electrode 143, and drive the heater 144 according to a certain condition to remove the collected fine particles, e.g., bacteria and ultra-fine dust. In a preferred implementation example of the present disclosure, the control unit 170 may be configured to operate the heater 144 when it is determined that fine particles of a reference amount of more are collected between electrodes, according to the output signal changes of the electrode.

In this regard, the control unit 170 may previously store reaction temperature information of fine particles matched according to types of the fine particles, and may determine information of the detected fine particles by comparing a temperature at which the output signal change of the electrode occurs in an operation of the heater 144 with the previously stored reaction temperature information. The reaction temperature information of the fine particles may be specific temperature information regarding a temperature at which fine particles generally existing in the inside of the vehicle may be removed, and the reaction temperature information may be stored separately for the fine particles. The control unit 170 may analyze an output signal from the sensing unit 140 and estimate information about fine particles collected and removed in the sensing unit 140 based on temperature information regarding a temperature at which bacteria are dissipated, temperature information regarding a temperature at which ultra-fine dust is removed, or the like. As described above, most bacteria are dissipated within several seconds at a temperature of 130° C. or higher, and ultra-fine dust may be removed within several seconds at a temperature of 500° C. or higher, such that such temperature information may be previously stored as the reaction temperature information in the control unit 170, and may be matched to temperature information at a time instant where an actual output signal change is detected, thereby estimating a removal target.

To this end, when the control unit 170 operates the heater 144, the control unit 170 may drive the heater 144 at a first voltage for driving the heater 144 for increasing the temperature of the sensing unit 140 to preset first reaction temperature information or higher and at a second voltage for increasing the temperature of the sensing unit 140 to preset second reaction temperature information or higher. Thus, when the control unit 170 operates the heater 144, the control unit 170 may drive the heater at the preset first voltage to monitor the output signal change of the electrode, determine whether bacteria are dissipated, and drive the heater 144 at the preset second voltage to remove the particles remaining in the sensing unit 140.

As described above, the inlet 110 may be connected to the inside of the vehicle to introduce air inside the vehicle, and the sensing unit 140 may be connected to the outlet 150 for discharging the air to the outside in a downstream side thereof. A fan may be installed in a discharging path connecting the sensing unit 140 with the outlet 150, and according to driving of the fan, air flow from the inlet 110 to the outlet 150 may be formed.

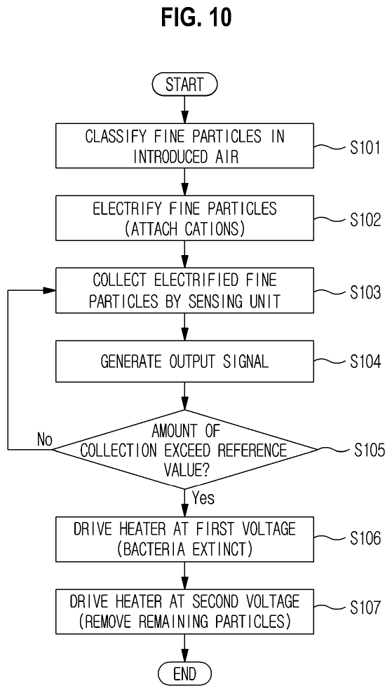

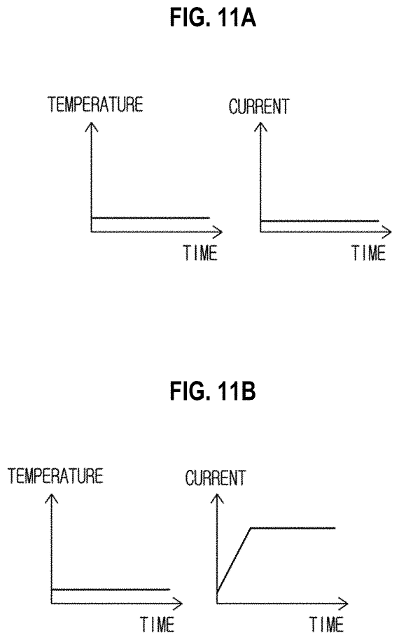

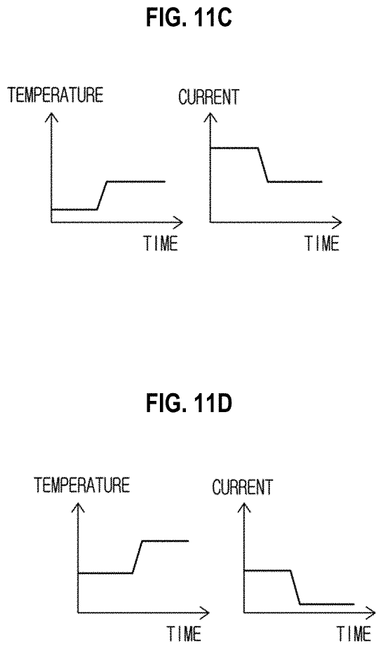

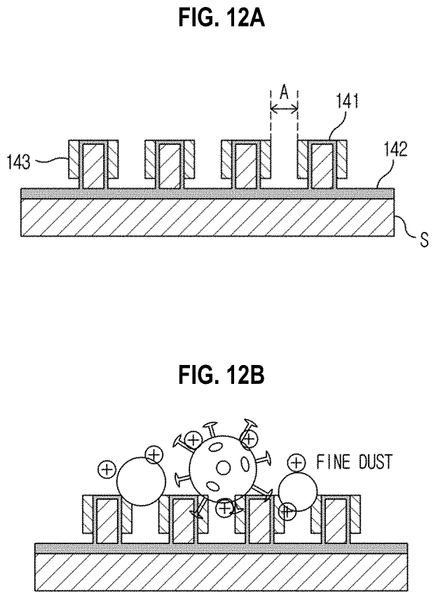

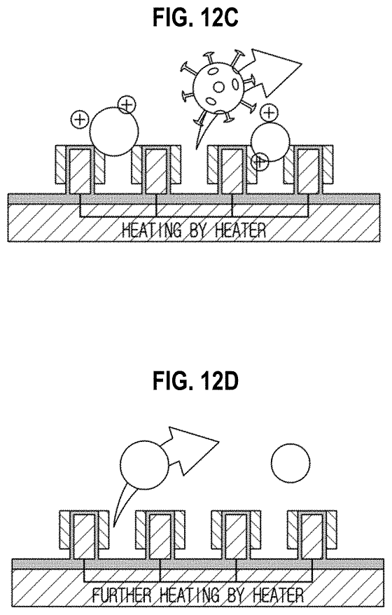

In relation to the method for controlling driving of the particulate matter sensing device according to an embodiment of the present disclosure, FIG. 10 is a flowchart related to the method for controlling driving. FIGS. 11A-11D are graphs showing temperature and current changes over time for each operation, and FIGS. 12A-12D show a state of a sensing unit for each operation to describe an operating principle where fine particles are collected and removed.

A detailed operation of the method for controlling driving of the particulate matter sensing device according to a preferred embodiment of the present disclosure will be described with reference to the flowchart of FIG. 10.

In an initial stage, as shown in FIG. 11A, an internal temperature of the sensing unit is a room temperature because the heater is not driven, and current does not flow between IDE electrodes (a short-circuit state). Thus, the detected current and temperature are output in the form of a graph shown in FIG. 11A. In addition, as shown in FIG. 12A, the fine particles are not collected in the electrode of the sensing unit.

Referring to FIG. 10, after the initial stage, when the air including the fine particles is introduced through the inlet of the particulate matter sensing device, the particles in the introduced air may be classified by the particle classifying unit according to sizes, in operation S101. The particle classifying operation may be an operation of classifying the particles according to sizes to improve sensing accuracy for a target to be detected, and current and temperature maintain a state as shown in FIG. 11A.

Thereafter, particles classified as having sizes to be detected among the classified particles may move to the corona discharging unit side, and cations may be attached to the moved particles by the corona discharging unit, thereby electrifying the particles, in operation S102. In the particle electrifying operation, current and temperature maintain the state as shown in FIG. 11A.

The electrified particles may move to the sensing unit and may be collected on the IDE electrode of the sensing unit as shown in FIG. 12B, in operation S103. In such a collecting operation, the heater has not been driven yet, such that the temperature of the sensing unit maintains the room state. On the other hand, the fine particles may be collected between IDE electrodes to form a current path, such that current increase with increase of the amount of particles collected over time may be identified. Thus, an output signal is generated due to the current increase in operation S104, and when the current increase is made to a certain level as shown in FIG. 11B, it may be determined that the fine particles of a sufficient amount are collected on the electrode, in operation S105. However, bacteria or ultra-fine particles may be difficult to distinguish merely with the output signal identified up to this operation, and the control unit may determine whether harmful substances including the bacteria and the ultra-fine particles are sensed. Thus, before the heater is driven, the control unit may be configured to determine whether the harmful substances are sensed to a reference or more and to transmit a notification regarding the sensing.

An operation of driving the heater by the control unit separately from the notification regarding the sensing may be performed in operations S106 and S107.

In this regard, whether the amount of collection exceeds a reference may be determined by a detected output signal change, for example, by setting a reference current value for driving the heater. On the other hand, by regarding a time instant at which the increase degree of increase of current changes due to completion of collection of sufficient fine particles as a heater driving time, driving of the heater may be controlled based on a result of monitoring the output signal change.

Meanwhile, in relation to a heater driving scheme, by considering a temperature at which bacteria and fine particles are removable, heater driving may be controlled to be performed through two stages. FIG. 12C shows a change in the sensing unit in the operation of driving the heater, describing that the bacteria are carbonized and dissipated due to heater driving.

For example, the heater driving operation may include first heater driving operation S106 of dissipating the bacteria by driving the heater at the preset first voltage and second heater driving operation S107 of removing the particles remaining in the sensing unit by driving the heater to the preset second voltage after an elapse of a specific time.

In this regard, in the first heater driving operation according to operation S106, the bacteria, which are organic matters, are dissipated and thus become carbides, according to heater driving, and in this case, as the bacteria are attached or detached, the current path is reduced, thus reducing the current. Moreover, when the dissipated bacteria are not attached or detached, the total resistance is affected by an electrical conductivity difference between the bacteria before and after dissipation, causing a current change. That is, regardless of whether the bacteria are attached or detached, the current change occurs, and by sensing the current change, whether the bacteria are sensed may be determined.

Such a current change is shown in FIG. 11C, and when the bacteria are dissipated in first heater driving operation S106, the temperature increases slightly and measured current also increases slightly as shown in FIG. 11C. At this time, the reduced current change may be monitored and the concentration of the collected bacteria may be estimated based on the monitored output signal change.

Meanwhile, by further increasing the temperature of the heater through second heater driving operation S107, an operation of controlling all of the ultra-fine particles may be performed. This operation is an operation of substantially initializing the sensing unit and the particulate matter sensing device, and through this operation, as shown in FIG. 12D, the remainders of the bacteria that are not attached or detached and the fine dust may be volatilized as CO₂ and thus removed, by reacting with oxygen at high temperature.

FIG. 11D shows temperature and current change in second heater driving operation S107, in which the temperature increases to the temperature corresponding to the second voltage and the remaining fine particles remaining in the sensing unit may be discharged through the outlet, such that the current may maintain the short-circuit state as in the initial operation.

While the present disclosure has been shown and described in relation to specific embodiments thereof, it would be obvious to those of ordinary skill in the art that the present disclosure can be variously improved and changed without departing from the spirit of the present disclosure provided by the following claims.

1. A particulate matter sensing device comprising:
an inlet through which air is introduced;
a particle classifying unit configured to classify particles included in the air introduced through the inlet;
a corona discharging unit configured to electrify the particles passing through the particle classifying unit; and
a sensing unit configured to collect the particles electrified by the corona discharging unit.

2. The particulate matter sensing device of claim 1, wherein the sensing unit comprises an electrode having a plurality of intervals to collect the particles electrified by the sensing unit; and
a control unit configured to determine whether fine particles are detected based on a result of monitoring an output signal change of the electrode.

3. The particulate matter sensing device of claim 1, further comprising a heater configured to increase a temperature of a side of the sensing unit.

4. The particulate matter sensing device of claim 2, further comprising a heater installed under the electrode and configured to increase a temperature of a side of the electrode, wherein the control unit operates the heater according to the output signal change of the electrode.

5. The particulate matter sensing device of claim 4, wherein the control unit previously stores reaction temperature information of fine particles matched according to types of the fine particles; and
the control unit determines information of detected fine particles by comparing a temperature at which the output signal change of the electrode occurs when operating the heater with the previously stored reaction temperature information.

6. The particulate matter sensing device of claim 4, wherein when the control unit operates the heater, the control unit drives the heater at a preset first voltage to monitor the output signal change of the electrode, and drives the heater at a preset second voltage to remove remaining particles in the sensing unit.

7. The particulate matter sensing device of claim 1, wherein the particle classifying unit is a virtual impactor comprising a major flow unit and a minor flow unit.

8. The particulate matter sensing device of claim 1, wherein the sensing unit comprises a plurality of insulating protrusions extending in a side longitudinal direction on a substrate, a plurality of interdigitated electrode (IDE) electrodes arranged alternately in parallel on a sidewall part of the insulating protrusions, and a heater configured to heat the plurality of insulating protrusions.

9. The particulate matter sensing device of claim 1, wherein the inlet is connected to an inside of a vehicle to introduce air in an inside of the vehicle, the sensing unit is connected to an outlet for discharging the air to an outside, and a fan is installed in a discharging path connecting the sensing unit with the outlet.

10. The particulate matter sensing device of claim 9, further comprising:
a substrate on which the particle classifying unit, the corona discharging unit, and the sensing unit are positioned;
a housing positioned on the substrate, the housing comprising a flow path connecting the inlet with the outlet; and
a cover covering a side of the housing;
wherein the particulate matter sensing device is integrated into the housing and the cover.

11. A method for controlling driving of a particulate matter sensing device, the method comprising:
a particle classifying operation comprising classifying fine particles of air introduced through an inlet by a particle classifying unit;
a particle electrifying operation comprising electrifying the fine particles by a corona discharging unit;
a signal generating operation comprising generating an output signal by collecting the electrified fine particles, by a sensing unit comprising an interdigitated electrode (IDE) electrode; and
a sensing operation comprising detecting the fine particles based on a change of the output signal, by a control unit.

12. The method of claim 11, wherein the sensing operation comprises heating a side of the sensing unit by a heater when determining that the fine particles of a reference amount or more are collected between electrodes, by the control unit.

13. The method of claim 12, wherein the control unit previously stores reaction temperature information of fine particles matched according to types of the fine particles, and
the sensing operation further comprises, after the heating, determining information of detected fine particles by comparing a temperature at which the change of the output signal of the electrode occurs when operating the heater with the previously stored reaction temperature information, by the control unit.

14. The method of claim 12, wherein the heating further comprises:
a first heater driving operation comprising driving the heater at a preset first voltage, by the control unit; and
a second heater operating operation comprising driving the heater at a preset second voltage after an elapse of a preset time to remove remaining particles in the sensing unit.
